(19) United States
(12) Patent Application Publication
(10) Pub. No.: US 2006/0125624 A1
(43) Pub. Date: Jun. 15, 2006

(54) Passive infrared motion sensor

(76) Inventors: Michael Ostrovsky, Brooklyn, NY (US); Paul Soccoli, New Hyde Park, NY (US); William J. Rose, West Hartford, CT (US); Alfred J. Lombardi, Syosset, NY (US); James A. Porter, Farmingdale, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/201,440

(22) Filed: Aug. 10, 2005

Related U.S. Application Data
(60) Provisional application No. 60/602,478, filed on Aug. 18, 2004.

(51) Int. Cl. G08B 23/00; H01H 47/26; G08B 13/00

(52) U.S. Cl. 340/527; 340/541; 307/117

(57) ABSTRACT

An intelligent occupancy sensor, such as a Passive InfraRed (PIR) sensor, with variable adaptive timeout. When a person first walks into the room and, after a very short time, walks out of the room, the occupancy sensor operates with a short timeout. When, however, a person lingers in the room, the occupancy sensor switches to another mode of operation where the timeout increases or decreases based on the frequency that the sensor detects motion in the room and the amplitude and/or duration of the signal of the detected motion.

This application claims the benefit of Provisional Application Ser. No. 60/602,478 filed Aug. 18, 2004.

### BACKGROUND OF THE INVENTION

1. Field of the Invention

This invention relates generally to lighting controls and more specifically to Passive InfraRed motion sensors for automatically controlling the lights in a room.

2. Description of the Related Art

To conserve energy, Passive InfraRed (PIR) motion sensors are used in combination with wall switches to turn on the lights in a room when a person enters, and turn the lights off at a fixed preset time duration after motion in the room is no longer detected. A problem that exists with this system is that the lights in the room will automatically go off after a predetermined period of time after motion is last sensed, even if a person is still in the room. This can happen if the IR radiation level from the person in the room has not changed or the movement of the person is not sufficient to be registered by the sensor. Thus, the lights in the room can go off when a person in the room is quietly working at his/her desk, or when two persons are sitting at a table while talking about a common issue. In another situation, if a secretary walks into the room and then immediately walks out, and no other motion is detected in the room, the lights will remain on for the preset interval of time and not extinguish immediately.

Thus, a main problem with PIR occupancy sensors used to control the lights of a room is that the lights usually stay on for a fixed period of time and that this time period is usually set for a long period of time to prevent the lights from cycling while a person is in the room. To prevent the lights in a room from cycling on and off during occupancy, the sensors should have a time delay which is large enough to cover the interval between two movements which the sensor can register. As the time delay is set to be large to reduce the possibility that the lights will turn off during occupancy, so will the use of electricity be increased as the lights are now on for a longer time. Usually, the time delay in PIR occupancy sensors is preset to a constant value during installation and, therefore, may not be set to optimally control the lighting in the room.

What is needed is a PIR sensor which provides an improved method of controlling the on-off time cycle of lights in a room.

### SUMMARY OF THE INVENTION

The intelligent PIR sensor here disclosed has variable adaptive timeout. When a person first walks into the room and, after a very short time, walks out of the room, the PIR sensor operates with a short timeout. This allows the room lights to be turned off relatively soon after the person leaves the room and is here referred to as the “walk-through” mode. This mode helps to reduce the use of energy. When, however, a person lingers in the room, the PIR sensor switches to another mode of operation where the timeout does not stay constant but increases or decreases where the change is determined by the frequency that the sensor detects motion in the room and the amplitude and/or duration of the signal of the detected motion.

In one aspect of the invention, a method of controlling the lights in a room with an occupancy sensor is provided. An initial timeout period is set for an occupancy sensor to operate a light before the timeout period expires upon sensing motion. A signal representing a motion sensed is compared to a first limit and a second limit where the first limit is wider than and brackets the second limit. The motion sensed is identified as a big motion if the signal crosses the first limit at least once and as a small motion if the signal is within the first and second limits. The initial timeout period is adjusted if the motion sensed is equal to a small motion.

In one embodiment, the timeout period is not changed (maintained) if the motion sensed is identified as a big motion. However, if the motion sensed is identified as a small motion, the timeout period is compared with a time interval between two previous sensed motions, and if the time interval is greater than a percent of the timeout period, then the timeout period is increased. On the other hand, if the time interval is less than a percent of the timeout period, then the timeout period is decreased. If the time interval is not greater than or less than a percent of the timeout period, then the timeout period is not changed.

### BRIEF DESCRIPTION OF THE DRAWINGS

The aforementioned features and advantages of the present invention as well as additional advantages thereof will be more readily understood upon consideration of the following detailed description of a preferred embodiment of the invention when taken in conjunction with the following drawings wherein like parts are represented by similar reference numbers.

FIG. 1 is a block diagram showing a Passive InfraRed motion sensor according to the present invention; and

FIG. 2 is a flow diagram showing the steps of the algorithm of the processor of FIG. 1.

### DETAILED DESCRIPTION

In the following description of the exemplary embodiment, reference is made to the accompanying drawings which form a part hereof, and in which is shown by way of illustration the specific embodiment in which the invention may be practiced. It is to be understood that other embodiments may be utilized as changes may be made to the structure and/or method without departing from the scope of the present invention.

A problem with PIR occupancy sensors connected to electrical circuits used to control the lights in an area such as an office or a room is that the PIR sensors generate a signal for a set interval of time when the IR radiation level changes as a result of movement by an occupant, and then only if the movement is sufficient to be registered by the sensor. Present day PIR occupancy sensors used to control the lights in a room usually have a time delay that is large enough to cover the interval between two successive movements which can be registered by the sensor. As the time delay between the intervals increases, the operation of the PIR occupancy sensor becomes more reliable because premature turn off of the lights is further minimized. But, because the lights are on for a longer period of time, the savings realized in energy use is decreased.

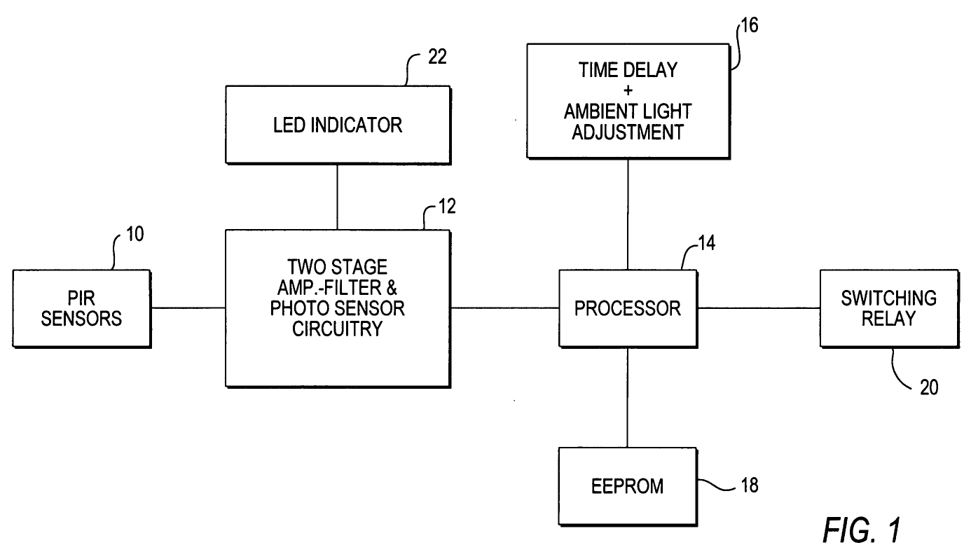

In this invention, and referring to FIG. 1, the occupancy sensor 10 can be in the form of a wall switch having one or two PIR sensors coupled to send signals to a two stage amplifier-filter which includes photo sensor circuitry 12. Signals from the amplifier-filter and photo sensor circuitry 12 are directed to processor 14, and time delay and ambient light adjustment circuit 16 is provided to manually set the time delay and adjust for ambient light conditions. EEPROM memory chip 18 is coupled to processor 14 and stores information about previous settings. Relay 20 is controlled by processor 14 to either make or break the electrical connection within a current carrying line to control the flow of power to the lights in a room. An LED indicator 22 is coupled to the two stage amplifier-filter and photo sensor circuitry to indicate when the PIR sensors 10 register occupancy in the room. Although an LED is shown as a visual means of indication, it should be understood that other means of indication can be provided such as an audio buzzer.

The PIR sensors 10 monitor a room for a change of IR radiation, and the amplifier-filter and photo sensor circuitry 12 generates a pulse signal when the IR radiation level changes because of motion in the room. The processor 14 provides intelligent control of the lighting load by operating the switching relay to its on and off positions based on an adaptive algorithm in the processor. The algorithm uses information received from the amplifier filter and photo sensor 12, the time delay and ambient light adjustment circuit 16, and information stored in the EEPROM 18 of previous settings.

The intelligent PIR sensor here disclosed has variable adaptive timeout. A timeout may be defined as the amount of time that a light is on during occupancy before being turned off because no occupancy has been detected. When a person first walks into the room and, after a very short time, walks out of the room, the PIR sensor will operates with a short timeout. This allows the room lights to be turned off relatively soon after the person leaves the room and is here referred to as the “walk-through” mode. This mode helps to reduce the use of energy. When, however, a person lingers in the room, the PIR switches to its base mode of operation where the timeout is determined by the preset interval of time which was set during installation. During use, with this invention, the timeout does not stay constant. It increases or decreases where the change is determined on the frequency that the sensor detects motion and the amplitude of the signal of the detected motion. A manually operated control provides adjustments for different levels of light.

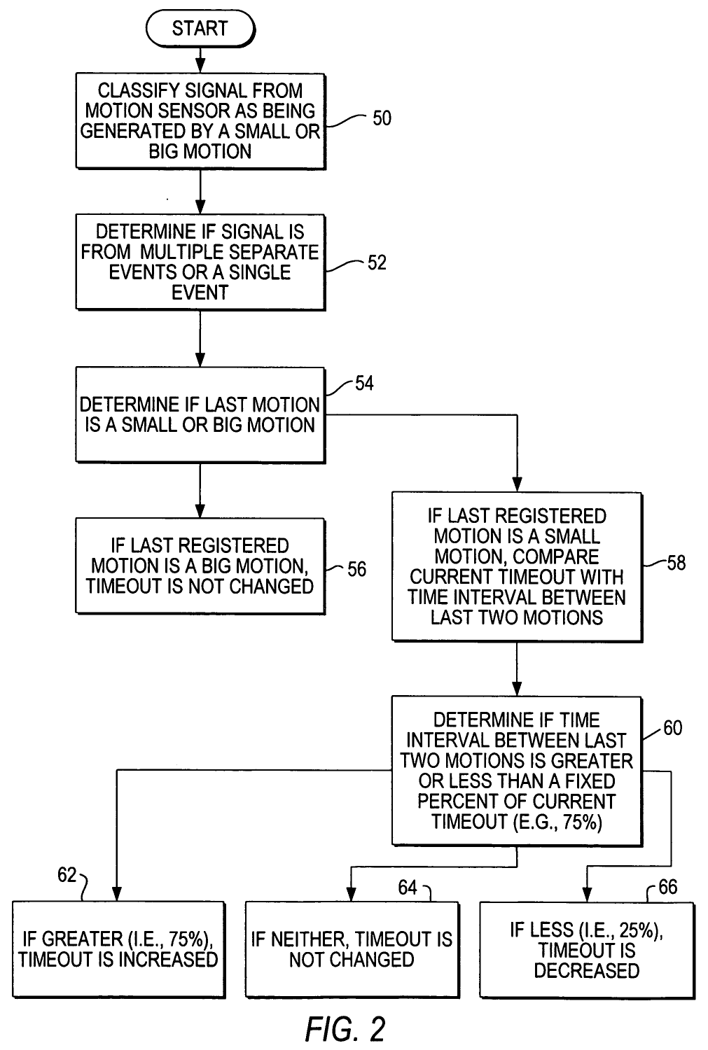

Referring to FIG. 2, there is shown the steps of the algorithm used by the sensor to control the lights of a room. Initially, the processor compares the input signal from the motion sensor with two sets of limits, a first set of limits and a second set of limits. The first set of limits is wider than and brackets the second set of limits. In step 50, the signal is identified as representative of a small motion or a big motion. If the signal crosses the first set of limits at least once, it is classified as a big motion. If the signal does not cross the first set of limits, but remains between the wide and narrow limits, the motion is classified as a small motion. Advancing to step 52, the signals of the small or big motions are classified as being for multiple or separate events. The signals are of multiple events if there are predefined non-occupancy time intervals between the signals. Otherwise they are classified as being of a single event. At step 54, the signal for the last registered motion is checked to determine if it is for a small motion or a big motion. If the motion is identified as a big motion the processor goes to step 56. At step 56, when the motion is identified as a big motion, the current timeout, the time delay in box 16 of FIG. 1 is not changed. On the other hand, if the motion is identified as a small motion the processor goes to step 58. At step 58, when the motion is identified as a small motion, the current timeout is compared with the time interval between the last two motions and, in step 60, the time interval between the last two motions is examined to determine if it is greater or less than a fixed percentage of the current timeout. If the time interval is greater than a fixed amount (e.g., 75%), then in step 62, the timeout is increased by either a fixed amount or a percentage of the current timeout but not greater than a preset maximum amount. If the time interval is less than a fixed amount (e.g., 25%), then in step 66, the timeout is decreased by a fixed amount or a percentage of the current timeout, but not less than a preset minimum amount. If the time interval is neither greater nor less than the fixed percentage of the current timeout then, at step 64, the timeout is not changed.

Under normal operating conditions, the timeout is not changed to be less than the timeout set during installation or greater that the maximum value. Each time the program makes a change in the timeout setting, the processor uses the new setting as the default timeout setting. The initial value of the base timeout is set by the user/installer and, in this invention, does not stay constant. The base timeout (the amount of time that the lights are on) is initially set by the user/installer. Thereafter, the magnitude of timeout is determined by occupancy time (the length of time that a person stays in the room) and increases as a function of occupancy time. At some instant before the timeout period expired, a sensor can be provided to alert the occupant of the room that the timeout period is about to expire. If motion is detected after the alert, the processor switches from the “walk-through” mode (if it is in this mode) or increases the base mode timeout period. If, however, motion is detected after the warning alert and before the lights are turned off, or some small interval of time such as, for example, 30 seconds to 1 minute, the base timeout is increased because there is the probability that the current base timeout is too short.

While there have been shown and described and pointed out the fundamental novel features of the invention as applied to the preferred embodiment as is presently contemplated for carrying then out, it will be understood that various omissions and substitutions and changes of the form and details of the device and the method illustrated and in the operation may be made by those skilled in the art, without departing from the spirit of the invention.

What is claimed is:

1. A method of controlling the lights in a room with an occupancy sensor comprising the steps of:
setting a timeout period for an occupancy sensor to operate a light before the timeout period expires upon sensing motion;
comparing a signal representing a motion sensed to a first limit and a second limit wherein the first limit is wider than and brackets the second limit;
identifying the motion sensed as a big motion if the signal crosses the first limit at least once and as a small motion if the signal is within the first and second limits; and
adjusting the timeout period if the motion sensed is equal to a small motion.

2. The method of claim 1 wherein adjusting further comprises maintaining the timeout period if the motion sensed is identified as a big motion.

3. The method of claim wherein adjusting further comprises:
if the motion sensed is identified as a small motion, comparing the timeout period with a time interval between two previous sensed motions;
if the time interval is greater than a percent of the timeout period, then increasing the timeout period;
if the time interval is less than a percent of the timeout period, then decreasing the timeout period; and
if the time interval is not greater than or less than a percent of the timeout period, then maintaining the timeout period.

4. The method of claim 3 wherein increasing the timeout period includes increasing a fixed amount or as a percent of the timeout period, but not greater than a preset maximum value.

5. The method of claim 3 wherein decreasing the timeout period includes decreasing a fixed amount or as a percent of the timeout period, but not less than a preset minimum value.

6. The method of claim 1 wherein the occupancy sensor is a Passive InfraRed (PIR) sensor.

7. The method of claim 1 further comprising generating an alert if the timeout period is about to expire before sensing a motion.
